(19) United States
(12) Patent Application Publication
(10) Pub. No.: US 2021/0337791 A1
(43) Pub. Date: Nov. 4, 2021

(54) Methods For Killing Insects Such As Drosophila species

(71) Applicant: The United States of America, as represented by the Secretary of Agriculture, Washington, DC (US)

(72) Inventors: Man Y. Choi, Albany, OR (US); Robert K. Vander Meer, Newberry, FL (US); Satya P. Chinta, Gainesville, FL (US)

(21) Appl. No.: 17/245,165

(22) Filed: Apr. 30, 2021

Related U.S. Application Data
(60) Provisional application No. 63/019,495, filed on May 4, 2020.

(51) Int. Cl. A01N 33/10; A01N 25/00

(52) U.S. Cl. CPC A01N 33/10; A01N 25/006

(57) ABSTRACT

Methods for killing insects (e.g., Drosophila species such as Drosophila suzukii), involving treating an object or area with an insect (e.g., Drosophila species such as Drosophila suzukii) killing effective amount of a composition containing at least tyramine and/or N-methyl-tyramine, optionally a phagostimulant (e.g., sucrose), optionally food material (e.g., materials used to attract insects (e.g., Drosophila species such as Drosophila suzukii adults) such as grape juice, fruit juices, apple cider vinegars), optionally non-caloric sugars (e.g., sucralose and erythritol), and optionally a carrier.

### REFERENCE TO RELATED APPLICATION

This application claims the benefit of U.S. Provisional Application No. 63/019,495, filed 4 May 2020, which is incorporated herein by reference in its entirety.

### BACKGROUND OF THE INVENTION

Disclosed herein are methods for killing insects (e.g., Drosophila species such as Drosophila suzukii) involving treating an object or area with an insect (e.g., Drosophila species such as Drosophila suzukii) killing effective amount of a composition containing tyramine and/or N-methyl-tyramine, optionally food material, optionally a phagostimulant, optionally non-caloric sugars, and optionally a carrier.

In invertebrates, octopamine (OA) and tyramine (TA) are functional homologs to the vertebrate adrenergic neurotransmitters, noradrenaline and adrenaline (Roeder, T., Annual Review Entomology, 50: 447-47 (2005)) and, therefore, have a wide range of physiological activities. TA and OA are the only non-peptide neurotransmitters/hormones found in insects, and interestingly these biogenic amines have no activity in vertebrates (Roeder 2005). The biogenic amines are biosynthesized and stored in the insect brain. When released into the hemolymph they bind to corresponding G-Protein-coupled receptors (GPCRs), e.g., TAR (TyrAmine Receptor), that initiate specific biological functions in insects. OA has been the more studied of the two insect specific biogenic amines. Tyramine and N-methyl (M)-tyramine are found in a variety of plants. Tyramine is the natural ligand for the TAR and previously has not been considered to have negative effects on the insects that use it.

Our previous experience with biogenic amines guided initial feeding experiments with tyramine whose objective was to determine if raising tyramine levels in winged female fire ant sexuals would result in physiological changes associated with mating, such as wing loss, ovariole development, pheromone production, and wing muscle histolysis. This was the mode of action proposed in our U.S. Pat. No. 10,568,320; Vander Meer, R. K., and Chinta, S. P., “Biologically-based control methods for insect pests;” and WO 2018/169802 A1. Worker mortality was not expected nor considered a possibility since the biogenic amines are natural ligands for their receptors and biochemical mechanisms are in place that remove the ligand from the receptor when the biosynthetic need is met. They were not expected to be agonists. However, our observation of worker and queen fire ant mortality when tyramine was fed to small lab colonies was a “Eureka” moment for our project and was totally surprising and unexpected. Even more surprising was that workers fed tyramine had significant mortality across a wide range of concentrations: 1.0, 0.1, and 0.01% wt(g)/vol(L). Activity over this 100 fold range in concentrations is one of the requirements for an ant bait toxicant and very few compounds meet this requirement.

We then evaluated four other biogenic amines: octopamine, dopamine, serotonin, and histamine, as well as tyramine, all formulated at 1.0% for direct comparison. Surprisingly, only tyramine resulted in significant fire ant worker mortality. The other biogenic amines were no different than the sucrose controls.

Surprisingly, an experiment addressing pest ant specificity of tyramine using tawny crazy ant workers unexpectedly did not result in mortality greater than the controls. These surprising cross-species results illustrate that the toxicity effects of tyramine on fire ants are not automatically extendable to even other ant species, let alone other species of hymenoptera or other insects, and suggests that this is not a general insecticide.

Spotted wing drosophila (SWD), Drosophila suzukii, is a severe invasive pest attacking a wide range of ripening fruits including grapes, cherries and all berry crops. The infestation areas of SWD have been rapidly expanding across the U.S., Canada, and Europe. The estimated economic impact is $800 million per year in the U.S. alone, and increasing every year. SWD management has recently been ranked a top priority among small fruit growers. Currently, the only way to effectively control this destructive pest is through the use of chemical insecticides that have negative effects on the environment and human health, and has the potential to develop chemical resistance in insects. Therefore, there is a strong need to develop environmentally friendly alternatives for the control of SWD.

Herein we disclose methods for killing insects (e.g., Drosophila species such as Drosophila suzukii), involving treating an object or area with an insect (e.g., Drosophila species such as Drosophila suzukii) killing effective amount of a composition containing tyramine and/or N-methyl-tyramine, optionally food material, optionally a phagostimulant, optionally non-caloric sugars, and optionally a carrier.

### SUMMARY OF THE INVENTION

Methods for killing insects (e.g., Drosophila species such as Drosophila suzukii) involving treating an object or area with an insect (e.g., Drosophila species such as Drosophila suzukii) killing effective amount of a composition containing tyramine and/or N-methyl-tyramine, optionally food material, optionally a phagostimulant, optionally non-caloric sugars, and optionally a carrier.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

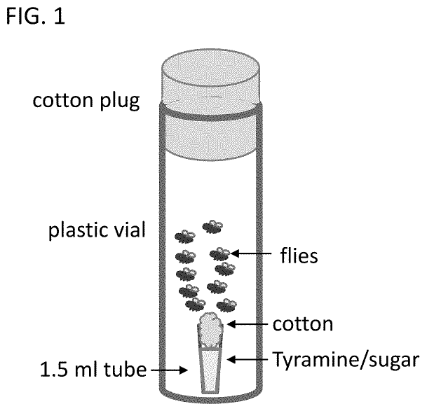

Exemplary FIG. 1 shows feeding test of D. suzukii in a cup as described below.

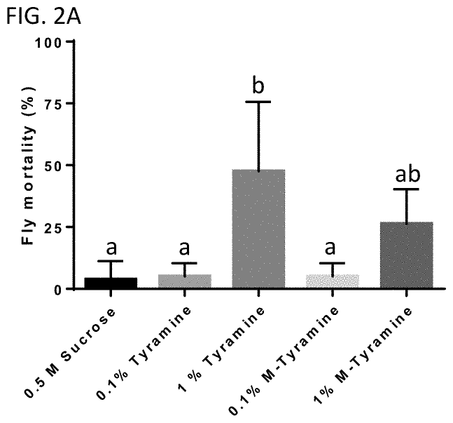

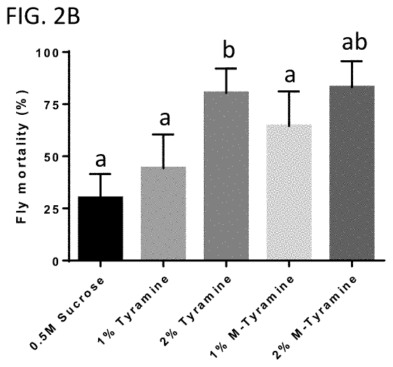

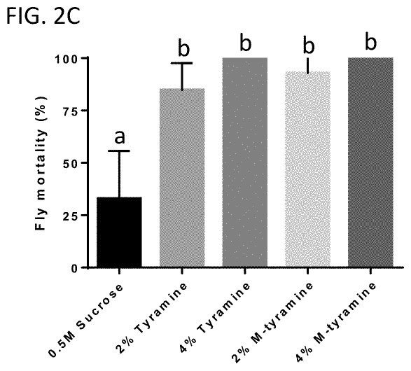

Exemplary FIG. 2A, FIG. 2B, and FIG. 2C show mortality of D. suzukii adults with different concentrations of tyramine or N-methyl-tyramine (M-tyramine) sucrose solutions as described below. Each treatment was replicated eight times. Different letters denote significant differences (P<0.05) by Tukey's multiple comparisons test (P<0.05).

### DETAILED DESCRIPTION OF THE INVENTION

Herein we describe methods for killing insects (e.g., Drosophila species such as Drosophila suzukii), involving treating an object or area with an insect (e.g., Drosophila species such as Drosophila suzukii) killing effective amount of a composition containing at least tyramine and/or N-methyl-tyramine, optionally a phagostimulant (e.g., sucrose), optionally food material (e.g., materials used to attract insects (e.g., Drosophila species such as Drosophila suzukii adults) such as grape juice, fruit juices, apple cider vinegars), optionally non-caloric sugars (e.g., sucralose and erythritol), and optionally a carrier (e.g., agronomically or physiologically or pharmaceutically acceptable carrier). Tyramine and/or N-methyl-tyramine in sugar or phagostimulant solution can be directly sprayed on small fruits or trees, or mixed in baits as non-toxic for humans and/or organic insecticide to control insects.

The carrier component can be a liquid or a solid material. The term “carrier” as used herein includes carrier materials such as those described below. As is known in the art, the vehicle or carrier to be used refers to a substrate such as a mineral oil, paraffin, silicon oil, water, membrane, sachets, disks, rope, vials, tubes, septa, resin, hollow fiber, microcapsule, cigarette filter, gel, fiber, natural and/or synthetic polymers, elastomers or the like. All of these substrates have been used to release an effective amount of a composition containing the compounds disclosed herein in general and are well known in the art. Suitable carriers are well-known in the art and are selected in accordance with the ultimate application of interest. Agronomically acceptable substances include aqueous solutions, glycols, alcohols, ketones, esters, hydrocarbons, halogenated hydrocarbons, polyvinyl chloride; in addition, solid carriers such as clays, laminates, cellulosic and rubber matrices and synthetic polymer matrices, or the like. The carrier or carrier material as used herein is defined as not including the body of an insect (e.g., Drosophila suzukii).

Other compounds (e.g., insecticides known in the art) may be added to the composition provided they do not substantially interfere with the intended activity and efficacy of the composition; whether or not a compound interferes with activity and/or efficacy can be determined, for example, by the procedures utilized below.

“Optional” or “optionally” means that the subsequently described event or circumstance may or may not occur, and that the description includes instances in which said event or circumstance occurs and instances where it does not. For example, the phrase “optionally comprising an insecticide known in the art” means that the composition may or may not contain an insecticide known in the art and that this description includes compositions that contain and do not contain an insecticide known in the art. Also, by example, the phrase “optionally adding an insecticide known in the art” means that the method may or may not involve adding an insecticide known in the art and that this description includes methods that involve and do not involve adding an insecticide known in the art.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation. Generally the concentration of the compounds will be, but not limited to, at least about 0.1% (e.g., at least 0.1%; for example in an aqueous solution), at least about 1% (e.g., at least 1%), preferably at least about 2% (e.g., at least 2%), preferably at least about 3% (e.g., at least 3%), preferably at least about 4% (e.g., at least 4%). The practical upper limits are generally 5-10% solutions (the tyramine and N-methyl-tyramine that we used was the salt form of tyramine and N-methyl tyramine which has about 5% and 10% aqueous solubility, respectively as a upper limit; in case of free base the upper limit is generally about 1% and 3.4%, respectively). However, higher concentrations than the limits shown could be obtained using solubilizing agents (e.g., DMSO of DMF) or chelating agents; for example, at least about 5% (e.g., at least 5%), preferably at least about 6% (e.g., at least 6%), preferably at least about 7% (e.g., at least 7%), preferably at least about 8% (e.g., at least 8%), preferably at least about 9% (e.g., at least 9%), and preferably at least about 10% (e.g., at least 10%). Concentrations lower than about 2% would require longer duration of exposure, such as the composition in a bait station to which the target insects have long term access to, thus increasing the total dose.

The term “tyramine” includes salts of tyramine and the term “N-methyl-tyramine” includes salts of N-methyl-tyramine. Acidic solutions (e.g., HCl) increase the solubility of the two active ingredients tyramine and N-methyl-tyramine. The salts come into play when an application requires a higher concentration than the free bases can provide. Additionally, the salts are less expensive than the free bases, and may be preferred because of cost.

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments and characteristics described herein and/or incorporated herein. In addition, the invention encompasses any possible combination that also specifically excludes any one or some of the various embodiments and characteristics described herein and/or incorporated herein.

The amounts, percentages and ranges disclosed herein are not meant to be limiting, and increments between the recited amounts, percentages and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g and all values within that range, whether specifically stated or not.

Unless defined otherwise, all technical and scientific terms used herein have the same meaning as commonly understood by one of ordinary skill in the art to which the invention belongs. The definitions herein described may or may not be used in capitalized as well as singular or plural form herein and are intended to be used as a guide for one of ordinary skill in the art to make and use the invention and are not intended to limit the scope of the claimed invention. Mention of trade names or commercial products herein is solely for the purpose of providing specific information or examples and does not imply recommendation or endorsement of such products. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

Flies and sugars: Drosophila suzukii used in these experiments were from a colony maintained at 22±5° C. under a photoperiod of L:D 16:8 h and a relative humidity of 60±5% RH at the Horticultural Crops Research Unit, USDA ARS in Corvallis, Oreg. Wildtype flies collected from infested fruits in Corvallis, Oreg., were used to start the colony. Standard rearing methods and diet are described by Woltz et al. (Journal of Applied Entomology, 139: 759-770 (2015)). Newly emerged adult males and females were collected daily and maintained in cages with water and diet until they were specific ages for experimentation.

The chemical components were tyramine (98%, Sigma-Aldrich), N-methyl-tyramine (shortened name=M-tyramine), 95%, Combi-Blocks, Inc.), and sucrose (>99%, Fisher Scientific, Hampton, N.H.).

The effect of tyramine and M-tyramine formulations on fly mortality-I: Ten 5-day old flies (5 males and 5 females) were introduced into a plastic vial and given a tube (1.5 ml) containing different water-based solutions (FIG. 1). For the first experiment various pairs were tested (FIG. 2A): (a) Sucrose 0.5 M only; (b) Tyramine 0.1%+Sucrose 0.5 M (0.1% Tyramine); (c) Tyramine 1%+Sucrose 0.5 M (1% Tyramine); (d) M-Tyramine 0.1%+Sucrose 0.5 M (0.1% M-Tyramine); and (e) M-Tyramine 1%+Sucrose 0.5 M (1% M-Tyramine).

The effect of tyramine and M-tyramine formulations on fly mortality-II: The second experiment consisted of the following (FIG. 2B): (a) Sucrose 0.5 M only; (b) Tyramine 1%+Sucrose 0.5 M (1% Tyramine); (c) Tyramine 2%+Sucrose 0.5 M (2% Tyramine); (d) M-Tyramine 1%+Sucrose 0.5 M (1% M-Tyramine), and (e) M-Tyramine 2%+Sucrose 0.5 M (2% M-Tyramine).

The effect of tyramine and M-tyramine formulations on fly mortality-III: The third experiment consisted of the following (FIG. 2C): (a) Sucrose 0.5 M only; (b) Tyramine 2%+Sucrose 0.5 M (2% Tyramine); (c) Tyramine 4%+Sucrose 0.5 M (4% Tyramine); (d) M-Tyramine 2%+Sucrose 0.5 M (2% M-Tyramine); and (e) M-Tyramine 4%+Sucrose 0.5 M (4% M-Tyramine). Survivorship of flies was checked daily for 7 days. Each pair per experiment was replicated at least eight times.

Results. Comparison of various tyramine formulations with sucrose on fly mortality: Fly survivorship was significantly decreased in 7 days (FIG. 2A-C). Surprisingly, 100% mortality occurred with 4% tyramine/0.5 M sucrose (P<0.05) and 4% M-tyramine/0.5 M sucrose (P<0.05) for 7 days, and over 85% mortality occurred with 2% tyramine/0.5 M sucrose (P<0.05) and 2% M-tyramine/0.5 M sucrose (P<0.05). However, the fly mortalities from the 0.1% tyramine solutions were not significantly different with the 0.5 M sucrose treatment (a negative control). The mortalities from 1% tyramine and M-tyramine solutions were not statistically consistent in the first and second experiments (FIG. 2A and FIG. 2B). Without being bound by theory, the different outcomes are probably due to the difference in sucrose control mortality for the two experiments, which may be related to the different fly colonies used for each bioassay.

Overall the results show that tyramine and M-tyramine dissolved in the fly phagostimulant, sucrose, gave surprisingly high fly mortality, especially at 2 and 4% concentrations, and higher tyramine and M-tyramine concentrations (e.g., prepared using solubilizing agents) are expected to enhance fly mortality. While we demonstrate mortality effects of tyramine and M-tyramine these compounds may well interfere with feeding activity as well and possibly at low concentrations. The results suggest the excessive tyramine might interfere with fly feeding activity.

In summary, the tyramine/sucrose formulation will not affect human health (Roeder, T., 2005). The tyramine/sucrose formulation can be directly applied as an insecticide for insects such as Drosophila species (e.g., Drosophila suzukii). The formulations can be used as a phagostimulant with conventional or biological insecticides. The formulations combined with conventional insecticides can reduce the amount of chemical dose sprayed in the field.

All of the references cited herein, including U.S. Patents and U.S. Patent Application Publications, are incorporated by reference in their entirety.

Thus, in view of the above, there is described (in part) the following:

A method for killing insects (e.g., Drosophila species such as Drosophila suzukii), said method comprising (consisting essentially of or consisting of) treating an object or area with an insects (e.g., Drosophila species such as Drosophila suzukii) killing effective amount of a composition comprising (consisting essentially of or consisting of) at least one compound selected from the group consisting of tyramine, N-methyl-tyramine, and mixtures thereof, optionally food material, optionally a phagostimulant, optionally non-caloric sugars, and optionally a carrier. The above method, wherein said composition contains food material. The above method, wherein said composition contains a phagostimulant. The above method, wherein said composition contains non-caloric sugars. The above method, wherein said composition is deployed in a bait station. The above method, wherein tyramine and/or N-methyl-tyramine is/are the sole insecticide in the composition. The above method, wherein said Drosophila species is Drosophila suzukii.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein).

The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41(1): 46-47 (2013): “ . . . . Written support for a negative limitation may also be argued through the absence of the excluded element in the specification, known as disclosure by silence . . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . . In other words, the inventor argued an example that passively complied with the requirements of the negative limitation . . . was sufficient to provide support . . . . This case shows that written description support for a negative limitation can be found by one or more disclosures of an embodiment that obeys what is required by the negative limitation . . . .”

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A method for killing Drosophila species, said method comprising treating an object or area with a Drosophila species killing effective amount of a composition comprising at least one compound selected from the group consisting of tyramine, N-methyl-tyramine, and mixtures thereof, optionally food material, optionally a phagostimulant, optionally non-caloric sugars, and optionally a carrier.

2. The method according to claim 1, wherein said composition contains food material.

3. The method according to claim 1, wherein said composition contains a phagostimulant.

4. The method according to claim 1, wherein said composition contains non-caloric sugars.

5. The method according to claim 1, wherein said composition is deployed in a bait station.

6. The method according to claim 1, wherein said Drosophila species is Drosophila suzukii.
